(19) United States
(12) Patent Application Publication
(10) Pub. No.: US 2026/0253885 A1
(43) Pub. Date: Aug. 27, 2026

(54) ANODE FOR LITHIUM SECONDARY BATTERY, AND LITHIUM SECONDARY BATTERY

(71) Applicant: SUMITOMO CHEMICAL COMPANY, LIMITED, Tokyo (JP)

(72) Inventors: Shingo MATSUMOTO, Tsukuba-shi (JP); Toshiaki KUMAGAI, Tokyo (JP); Yoji MATSUO, Niihama-shi (JP)

(21) Appl. No.: 18/714,528

(22) PCT Filed: Dec. 2, 2022
(86) PCT No.: PCT/JP2022/044562

§ 371 Date: May 29, 2024

(30) Foreign Application Priority Data
Dec. 10, 2021 (JP) 2021-200899

(51) Int. Cl. H01M 4/46; H01M 4/02; H01M 4/66; H01M 10/052

(52) U.S. Cl. CPC H01M 4/463; H01M 4/661; H01M 10/052; H01M 2004/021; H01M 2004/027

(57) ABSTRACT

An anode for a lithium secondary battery, including: aluminum, in which a thickness of the anode for a lithium secondary battery is 200 μm or less, in which, in X-ray diffraction measurement of an anode surface of the anode for a lithium secondary battery using CuKα as a radiation source, a crystallite size calculated from a half-width of a diffraction peak of an aluminum plane is less than 1000 Å.

### TECHNICAL FIELD

The present invention relates to an anode for a lithium secondary battery, and a lithium secondary battery.

Priority is claimed on Japanese Patent Application No. 2021-200899, filed Dec. 10, 2021, the content of which is incorporated herein by reference.

### BACKGROUND ART

In the related art, as for an anode included in a lithium secondary battery, studies are being conducted to improve battery performance using a material having a theoretical capacity higher than that of graphite, which is an anode material in the related art. As such a material, a metal material capable of occluding and releasing lithium ions like graphite has attracted attention.

For example, Patent Document 1 discloses a non-aqueous electrolytic solution battery using, as an anode, a laminated metal foil in which an aluminum metal layer is bonded to each of both surfaces of a metal base material layer that does not form an alloy with lithium.

### CITATION LIST

### Patent Document

### [Patent Document 1]

Japanese Patent No. 6139776

### SUMMARY OF INVENTION

### Technical Problem

As application fields of the lithium secondary batteries expand, further improvement in cycle characteristics is required. An anode used in a lithium secondary battery has room for improvement in cycle characteristics.

The “cycle characteristics” are evaluated by a discharge capacity retention ratio when charging and discharging are repeated. A high discharge capacity retention ratio when a secondary battery is repeatedly charged and discharged is evaluated as “good cycle characteristics”.

The present invention has been made in view of the above circumstances, and an object of the present invention is to provide an anode for a lithium secondary battery capable of improving cycle characteristics of a lithium secondary battery, and a lithium secondary battery using the same.

### Solution to Problem

The present invention includes the following [1] to [10].

[1] An anode for a lithium secondary battery, including: aluminum, in which a thickness of the anode for a lithium secondary battery is 200 μm or less, and in X-ray diffraction measurement of an anode surface of the anode for a lithium secondary battery using CuKα as a radiation source, a crystallite size calculated from a half-width of a diffraction peak of an aluminum (311) plane is less than 1000 Å.

[2] The anode for a lithium secondary battery according to [1], in which a material of the anode for a lithium secondary battery is aluminum, and a content ratio of an inevitable impurity contained in the aluminum is less than 0.1 mass %.

[3] The anode for a lithium secondary battery according to [1] or [2], in which a material of the anode for a lithium secondary battery is an alloy of aluminum and an element MI, the element M1 is one or more elements selected from the group consisting of Si, Ge, Sn, Ag, Sb, Bi, In, Mn, and Mg, and a content ratio of the element M1 to a total amount of the anode for a lithium secondary battery is 0.1 mass % or more and 8 mass % or less.

[4] An anode for a lithium secondary battery, including: a cladding material including an anode active material layer and a current collector layer, in which a thickness of the anode for a lithium secondary battery is 200 μm or less, the anode active material layer contains aluminum, and in X-ray diffraction measurement of an anode surface of the anode for a lithium secondary battery using CuKα as a radiation source, a crystallite size calculated from a half-width of a diffraction peak of an aluminum (311) plane is less than 1000 Å.

[5] The anode for a lithium secondary battery according to [4], in which a material of the current collector layer is an aluminum alloy having a lower content ratio of Al than the anode active material layer.

[6] The anode for a lithium secondary battery according to [4] or [5], in which a material of the current collector layer contains an element M2 which is one or more elements selected from the group consisting of Si, Fe, Ni, Cu, Mn, and Mg, and a content ratio of the element M2 to a total amount of the current collector layer is 0.1 mass % or more.

[7] The anode for a lithium secondary battery according to any one of [4] to [6], in which a material of the anode active material layer is aluminum, and a content ratio of an inevitable impurity contained in the aluminum is less than 0.1 mass %.

[8] The anode for a lithium secondary battery according to any one of [4] to [7], in which a material of the anode active material layer is an alloy of aluminum and an element M1, the element M1 is one or more elements selected from the group consisting of Si, Ge, Sn, Ag, Sb, Bi, In, Mn, and Mg, and a content ratio of the element M1 to a total amount of the anode active material layer is 0.1 mass % or more and 8 mass % or less.

[9] The anode for a lithium secondary battery according to any one of [1] to [8], in which a crystallite size is less than 900 Å.

[10] A lithium secondary battery including: the anode for a lithium secondary battery according to any one of [1] to [9].

### Advantageous Effects of Invention

According to the present invention, it is possible to provide an anode for a lithium secondary battery capable of improving cycle characteristics of a lithium secondary battery, and a lithium secondary battery using the same.

### BRIEF DESCRIPTION OF DRAWINGS

FIG. 1 is a schematic cross-sectional view showing an example of a anode for a lithium secondary battery of the present embodiment.

FIG. 2 is a schematic cross-sectional view showing an example of the anode for a lithium secondary battery of the present embodiment.

FIG. 3 is a schematic cross-sectional view showing an example of the anode for a lithium secondary battery of the present embodiment.

FIG. 4 is a schematic view of a lithium secondary battery of the present embodiment.

### DESCRIPTION OF EMBODIMENTS

### <Anode for Lithium Secondary Battery>

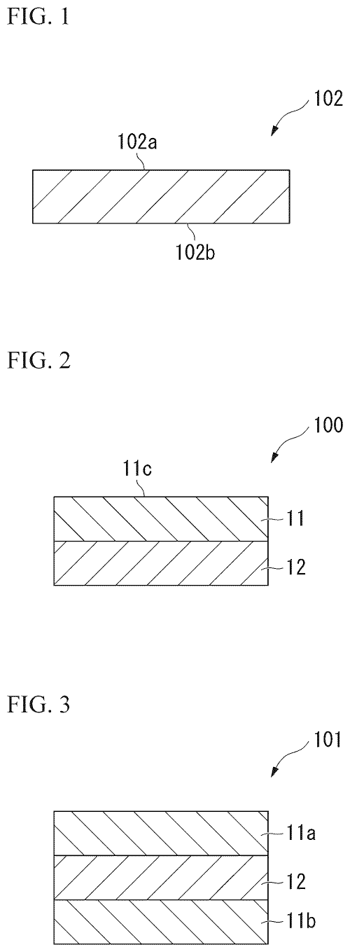

Hereinafter, an anode for a lithium secondary battery according to a first embodiment of the present invention will be described with reference to FIG. 1. In all the drawings below, the dimensions and ratios of each constituent element are appropriately different in order to make the drawings easier to see. Hereinafter, the anode for a lithium secondary battery according to the present invention may be abbreviated as “anode”.

### First Embodiment

FIG. 1 is a schematic cross-sectional view showing an example of the anode according to the present embodiment. An anode 102 shown in FIG. 1 is a single layer of aluminum having a thickness of 200 μm or less. The thickness of the anode 102 is preferably 1 μm or more, more preferably 4 μm or more, and still more preferably 5 μm or more.

The thickness of the anode 102 is, for example, 1 μm or more and 200 μm or less, 4 μm or more and 200 μm or less, or 5 μm or more and 200 μm or less.

The anode 102 is made of, for example, aluminum.

The anode 102 is, for example, an aluminum alloy 1.

The aluminum or the aluminum alloy 1, which is a material of the anode 102, will be described below.

In a case where a cathode is opposed to one surface 102a in the lithium secondary battery having the anode 102, a portion of the anode 102 on an one surface 102a side functions as an anode active material. At this time, one surface 102a corresponds to an “anode surface” in the present invention. The other surface 102b of the anode 102 is a surface of a current collector layer that functions as a current collector.

In the present embodiment, one surface 102a is used as the anode surface, but the other surface 102b can also be used as the anode surface depending on an arrangement of a counter electrode.

In X-ray diffraction measurement of the anode surface 102a using CuKα as a radiation source, a crystallite size of the anode 102 calculated from a half-width of a diffraction peak of an aluminum (311) plane is less than 1000 Å, preferably 900 Å or less, and still more preferably 800 Å or less.

In an aspect of the present invention, in a case where the anode 102 is particularly the aluminum alloy 1, in the X-ray diffraction measurement of the anode surface 102a using CuKα as the radiation source, the crystallite size calculated from the half-width of the diffraction peak of the aluminum (311) plane is less than 900 Å, preferably 890 Å or less, and more preferably 880 Å or less.

In a case where the anode 102 is made of aluminum, the above-described crystallite size tends to be in a range of 900 Å or more and less than 1000 Å, and in a case where the aluminum alloy is used as a forming material, the above-described crystallite size tends to be less than 900 Å.

A lower limit of the crystallite size is, for example, 300 Å or more, 400 Å or more, or 500 Å or more.

The above-described upper limit and lower limit of the crystallite size can be randomly combined.

Examples of the combination include 300 Å or more and less than 1000 Å, 400 Å or more and less than 900 Å, and 500 Å or more and less than 800 Å.

### [Method of Measuring Crystallite Size]

The X-ray diffraction measurement using CuKα as the radiation source is, specifically, a measurement performed using a device such as the X-ray diffractometer X'Pert PRO MPD (Spectris Co., Ltd) under conditions of a slit width of 2 mm, a voltage of 45 KV, a current of 40 mA, a scan speed of 4°/min, and a step of 0.016°, with a 2θ range of 10° to 90°. In the obtained diffraction pattern, the largest diffraction peak in a range of 2θ=78.18±1° is the diffraction peak of the aluminum (311) plane.

The half-width of the determined diffraction peak is calculated, and the crystallite size is calculated using the Scherrer equation L=Kλ/BCosθ (L: crystallite diameter, K: Scherrer constant, B: peak half-width).

Calculating a crystallite size by the Scherrer equation is a method that has been used in the related art. For example, “X-ray structural analysis—Determination of atomic arrangement—” published on Apr. 30, 2002, third edition, by Yoshio Waseda and Eiichiro Matsubara may be referred to. The Scherrer constant K used is 0.94.

In a charging step of the lithium secondary battery, a lithium alloying reaction in which Li is alloyed with the material constituting the anode occurs on the anode. The lithium alloying reaction proceeds in units of crystallites. In a case where the crystallite size of the anode surface at which the lithium alloying reaction occurs is small, Li and Al are likely to be uniformly alloyed between a plurality of crystallites during charging. In this case, the lithium alloying reaction proceeds uniformly in a depth direction over the entire region of the anode surface, so that a state of an aluminum metal foil is easily maintained, and a cycle retention ratio is less likely to decrease even when charging and discharging are repeated.

On the other hand, in a case where the crystallite size of the anode surface at which the lithium alloying reaction occurs is large, alloying of Li and Al is likely to occur locally during charging. In this case, when charging and discharging are repeated, the aluminum metal foil is likely to collapse, and the cycle retention ratio is likely to decrease.

Hereinafter, the aluminum or the aluminum alloy 1, which is the material of the anode 102, will be described.

### Aluminum

In the present specification, aluminum refers to aluminum having a purity of Al of 99 mass % or more. Regarding the aluminum, the purity of Al is preferably 99.8 mass % or more, more preferably 99.9 mass % or more, still more preferably 99.95 mass % or more, and even more preferably 99.99 mass % or more.

In the present specification, the purity of Al means the purity of Al excluding an additive element for alloying.

Compositions of the anode 102 and an anode active material layer 11, which will be described later, can be confirmed by an inductively coupled plasma (ICP) analysis method. For example, the compositions of the anode 102 and the anode active material layer 11 can be measured using an ICP optical emission spectrometer (manufactured by SII Nano Technology Inc., SPS3000).

Examples of a refining method for highly purifying aluminum to the above-described purity include a segregation method and a three-layer electrolysis method.

### (Segregation Method)

The segregation method is a purification method utilizing the segregation phenomenon during solidification of molten aluminum, and a plurality of methods have been put into practical use. As one form of the segregation method, there is a method of pouring molten aluminum into a container, and allowing refined aluminum to solidify from a bottom portion while heating and stirring the molten aluminum at an upper portion while rotating the container. By the segregation method, aluminum having a purity of 99.99 mass % or more can be obtained.

### (Three-layer Electrolysis Method)

As one form of the three-layer electrolysis method, there is a method in which first, an aluminum ground metal having a minimum aluminum content of 99 mass % or more is fed into an aluminum-copper alloy layer. Thereafter, in the method, with an anode in a molten state, an electrolytic bath containing, for example, aluminum fluoride and barium fluoride is disposed thereon, and high-purity aluminum is precipitated on a cathode. By the three-layer electrolysis method, high-purity aluminum having a purity of 99.999 mass % or more can be obtained.

The refining method for highly purifying aluminum is not limited to the segregation method and the three-layer electrolysis method, and other known methods such as a zone melting and refining method and an ultra-high vacuum melting method may be used.

The material of the anode 102 is, for example, an aluminum alloy 1 containing Al or an element M1. The element M1 is one or more elements selected from the group consisting of Si, Ge, Sn, Ag, Sb, Bi, In, Mn, and Mg.

In the aluminum alloy 1, for example, a non-aluminum phase containing the element M1 is dispersed in an aluminum phase. The element contained in the non-aluminum phase is, for example, Si.

A content ratio of the element M1 to a total amount of the anode 102 is preferably 0.1 mass % or more and 8 mass % or less, more preferably 0.2 mass % or more and 7.9 mass % or less, and still more preferably 0.5 mass % or more and 7.8 mass % or less.

In a case where a ratio of a mass of the element M1 is equal to or more than the above-described lower limit, crystal grains of Al are refined, and cycle characteristics of the lithium secondary battery can be improved. In a case where the ratio of the mass of the element M1 is equal to or less than the above-described upper limit, precipitation of the element M1 during the charging and discharging of the lithium secondary battery can be suppressed.

A content ratio of inevitable impurities contained in the aluminum constituting the anode 102 is preferably less than 0.1 mass %, more preferably 0.05 mass % or less, and still more preferably 0.01 mass % or less.

The anode 102 inevitably contains a small amount of metal impurities (inevitable impurities). Examples of such inevitable impurities include production residues that are inevitably mixed in a refining step. Specific examples thereof include Fe, Cu, and Si.

The inevitable impurities do not contain an element that is intentionally added. However, an element common to the intentionally added element may be contained as an inevitable impurity. The intentionally added element is specifically the above-described element M1.

For example, the anode 102 may contain Si as the element M1 to be intentionally added. In this case, Si may be contained as an inevitable impurity.

Examples of the inevitable impurities contained in the aluminum constituting the anode 102 include Fe and Cu. A total content of Fe and Cu is preferably 300 ppm or less.

The aluminum alloy 1 as the material of the anode 102 is preferably an aluminum alloy 1 obtained by intentionally adding an element to aluminum having a purity as high as 99.99 mass % or more. Whether or not the aluminum alloy 1 is such an aluminum alloy 1 can be confirmed, for example, by using an ICP emission spectrometer. For the aluminum alloy 1 obtained by intentionally adding a small amount (for example, about 0.1 mass %) of an element to high-purity (for example, a purity of Al of 99.99 mass % or more) aluminum, a peak corresponding to the intentionally added element appears to a separable degree in addition to the Al peak. In this case, the aluminum alloy 1 can be determined as an aluminum alloy 1 obtained by intentionally adding an element to high-purity aluminum.

On the other hand, in a case where a plurality of peaks having no intensity bias other than the Al peak appear in the analysis of the anode 102 using the ICP emission spectrometer, the aluminum alloy 1 can be determined as low-purity aluminum containing inevitable impurities.

### Second Embodiment

FIG. 2 is a schematic cross-sectional view showing an example of the anode according to the present embodiment. An anode 100 shown in FIG. 2 is a two-layer cladding material including the anode active material layer 11 and a current collector layer 12. In the anode 100, a surface 11c of the anode active material layer 11 (a surface of the anode active material layer 11 opposite to a surface in contact with the current collector 12) corresponds to the “anode surface” in the present invention.

Regarding the anode 100, the anode active material layer 11 and the current collector layer 12 may be in direct contact with each other, and for example, the current collector layer 12 may be exposed on both end surfaces of the anode 100.

In X-ray diffraction measurement of the surface 11c, which is the anode surface, a crystallite size calculated from a half-width of a diffraction peak of an aluminum (311) plane is less than 1000 Å. A method of measuring the crystallite size, a numerical range, and operational effects are the same as those of the first embodiment.

The anode active material layer 11 contains aluminum.

The anode active material layer 11 is made of, for example, aluminum.

The anode active material layer 11 is, for example, an aluminum alloy 1.

The aluminum or the aluminum alloy 1, which is a material of the anode active material layer 11, is the same as the aluminum or the aluminum alloy 1 described in the above anode 102.

A material of the current collector layer 12 is a metal foil containing a metal that can be alloyed with Li. Examples of such a metal include aluminum, silicon, and magnesium.

The current collector layer 12 may be, for example, an aluminum foil, a silicon foil, or a magnesium foil From the viewpoint of easy cladding with the anode active material layer 11, the current collector layer 12 is preferably an aluminum alloy foil. In this case, as the current collector layer 12, an alloy is prepared to have a composition having a potential that is less likely to be alloyed with Li than the anode active material layer 11.

Li is less likely to intrude into the current collector layer 12 formed of the above material than into the anode active material layer 11. Accordingly, in a case where charging and discharging are repeated, the current collector layer 12 is likely to maintain the metal composition before charging.

The material of the current collector layer 12 is, for example, an aluminum alloy 2 containing Al and an element M2. The element M2 is one or more elements selected from the group consisting of Si, Fe, Ni, Cu, Mn, and Mg.

In the aluminum alloy 2, for example, a non-aluminum phase containing the element M2 is dispersed in an aluminum phase. The element contained in the non-aluminum phase is, for example, Si. The element M2 is an element that is intentionally added.

Examples of the material of the current collector include an aluminum-manganese alloy, an aluminum-silicon alloy, an aluminum-manganese-silicon alloy, an aluminum-magnesium alloy, and an aluminum-magnesium-silicon alloy.

A proportion of the element M2 contained in the current collector layer 12 is preferably 0.1 mass % or more, more preferably 0.5 mass % or more, and still more preferably 1 mass % or more. In addition, the proportion of the element M2 in the current collector layer 12 is, for example, 8 mass % or less, 6 mass % or less, and 5 mass % or less.

The above-described upper limit and lower limit of the proportion of the element M2 contained in the current collector layer 12 can be combined randomly. Examples of the combination include 0.1 mass % or more and 8 mass % or less, 0.5 mass % or more and 6 mass % or less, and 1 mass % or more and 5 mass % or less.

In a case where the element M2 is within the above range, a content ratio of Al in the current collector layer 12 is lower than that in the anode active material layer 11.

In this case, the current collector layer 12 is less likely to be alloyed with lithium than the anode active material layer 11, and the current collector layer 12 is likely to maintain the composition before charging when charging and discharging are repeated.

Since a thickness of each of the anode active material layer 11 and the current collector layer 12 does not affect the cycle characteristics, the thickness can be appropriately designed and changed in order to maintain or improve strength.

From the viewpoint of reducing a weight of the anode 100, the thickness of the anode active material layer 11 is, for example, preferably 3 μm or more and 200 μm or less, and the thickness of the current collector layer 12 is preferably 1 μm or more and 150 μm or less.

As an example of the anode 100, the anode active material layer 11 is aluminum and the current collector layer 12 is the aluminum alloy 2.

As an example of the anode 100, the anode active material layer 11 is aluminum having a purity of 99.99 mass % or more, and the current collector layer 12 is an aluminum-manganese alloy As an example of the anode 100, the anode active material layer 11 is aluminum having a purity of 99.99 mass % or more, and the current collector layer 12 is an aluminum-manganese-silicon alloy.

As an example of the anode 100, the anode active material layer 11 is made of aluminum having a purity of 99.99 mass % or more, and the current collector layer 12 is an aluminum-magnesium alloy.

As an example of the anode 100, the anode active material layer 11 is aluminum having a purity of 99.99 mass % or more, and the current collector layer 12 is an aluminum-magnesium-silicon alloy.

As an example of the anode 100, the anode active material layer 11 is aluminum having a purity of 99.99 mass % or more, and the current collector layer 12 is an aluminum-silicon alloy.

As an example of the anode 100, the anode active material layer 11 is the aluminum alloy 1 and the current collector layer 12 is the aluminum alloy 2.

As an example of the anode 100, the anode active material layer 11 is an aluminum-silicon alloy, and the current collector layer 12 is an aluminum-manganese alloy. The aluminum-silicon alloy is an alloy of aluminum having a purity of 99.99 mass % or more and silicon, and a content ratio of silicon contained in a total amount of aluminum and silicon is 0.1 mass % or more and 8 mass % or less.

As an example of the anode 100, the anode active material layer 11 is an aluminum-silicon alloy, and the current collector layer 12 is an aluminum-manganese-silicon alloy.

As an example of the anode 100, the anode active material layer 11 is an aluminum-silicon alloy, and the current collector layer 12 is an aluminum-magnesium alloy As an example of the anode 100, the anode active material layer 11 is an aluminum-silicon alloy, and the current collector layer 12 is an aluminum-magnesium-silicon alloy.

As an example of the anode 100, the anode active material layer 11 is the aluminum-silicon alloy 1, and the current collector layer 12 is an aluminum-silicon alloy having a lower purity of Al than the aluminum-silicon alloy 1.

### Third Embodiment

FIG. 3 shows another aspect of the anode of the present embodiment. An anode 101 shown in FIG. 3 is a three-layer cladding material in which an anode active material layer 11a and an anode active material layer 11b forming a pair are directly laminated on both surfaces of the current collector layer 12. A surface of the anode active material layer 11a and a surface of the anode active material layer 11b each correspond to the “anode surface” in the present invention.

In X-ray diffraction measurement of the above-described anode surface of the anode 101, a crystallite size calculated from a half-width of a diffraction peak of an aluminum (311) plane is less than 1000 Å. A method of measuring the crystallite size, a numerical range, and operational effects are the same as those of the first embodiment.

In the anode 101, the crystallite size of only one of the two anode surfaces needs to be less than 1000 Å, and it is preferable that both the two anode surfaces satisfy a crystallite size of less than 1000 Å.

Materials of the anode active material layer 11b and the anode active material layer 11a may be the same as or different from each other. From the viewpoint of easy manufacturing, it is preferable that the materials of the anode active material layer 11b and the anode active material layer 11a are the same.

Here, “the material of the anode active material layer 11b and the material of the anode active material layer 11a are the same” means that the materials have the same constituent metal element.

For example, in a case where aluminum X is used as the anode active material layer 11a, the anode active material layer 11b preferably uses aluminum Y. Purities of the aluminum X and the aluminum Y may be the same as or different from each other.

Thicknesses of the anode active material layer 11b and the anode active material layer 11a may be the same as or different from each other. From the viewpoint of easy manufacturing, it is preferable that the thicknesses of the anode active material layer 11b and the anode active material layer 11a are the same.

Since a thickness of a coating layer is several nm or less, the crystallite size of the anode surface can be measured even in a case where the coating layer is provided.

### [Method of Measuring Cycle Retention Ratio]

For the anode for a lithium secondary battery, the cycle retention ratio is measured by the following method.

### (Manufacturing of Lithium Secondary Battery)

First, as a measurement target, a disk-shaped anode having a thickness of 30 μm and a diameter of φ15 mm is prepared.

Next, a LiCoO₂ foil (thickness 35 μm: manufactured by Nippon Chemical Industrial Co., Ltd.) is cut into a disk shape having a diameter of φ14.5 mm to manufacture a counter electrode.

Next, in a mixed solvent prepared by mixing ethylene carbonate (EC) and diethyl carbonate (DEC) at EC:DEC=30:70 (volume ratio), LiPF₆ is dissolved to 1.0 mol/L to manufacture an electrolytic solution.

A polyethylene porous separator is disposed between the anode surface of the anode and the counter electrode and accommodated in a battery case (standard 2032).

The electrolytic solution is injected into the battery case, and the battery case is sealed, whereby a coin type (full cell) lithium secondary battery having a diameter of 20 mm and a thickness of 3.2 mm is manufactured.

Next, the separator and a cathode are sufficiently impregnated with the electrolytic solution by allowing the coin type lithium secondary battery to be left at room temperature for 10 hours.

Next constant current-constant voltage charging in which constant current charging (occlusion of Li in Al) to 4.2 V at 1 mA is performed at room temperature and constant voltage charging at 4.2 V is then performed is performed for 5 hours.

Thereafter, constant current discharging in which discharging (release of Li from Al) to 3.4 V at 1 mA (0.2 C) is performed is performed, whereby initial charging and discharging is performed

A discharge capacity (mAh) at a 5th cycle and a discharge capacity (mAh) at a 30th cycle are measured, and the cycle retention ratio is calculated by the following expression.

Cycle retention ratio (%)=discharge capacity (mAh) at the 30th cycle/discharge capacity (mAh) at the 5th cycle×100

A cycle retention ratio of 90% or higher, obtained by the above expression, is evaluated as a high cycle retention ratio.

### <Manufacturing Method 1 of Anode for Lithium Secondary Battery>

A method of manufacturing the anode of the first embodiment will be described. A case where aluminum or the aluminum alloy 1 is used as the anode of the first embodiment will be described as an example.

### (Manufacturing of Aluminum)

In a case where aluminum is used as a material of the anode, first, the aluminum is highly purified by the above-described segregation method or the three-layer electrolysis method.

The obtained ingot of aluminum can be directly cut and used as the material of the anode.

### (Manufacturing of Aluminum Alloy 1)

In a case where the aluminum alloy 1 is used as the material of the anode, the element M1 is added to molten aluminum and melted at 680° C. or higher and 800° C. or lower to obtain a molten alloy of Al and the element M1.

The molten alloy is preferably subjected to a treatment of removing gas and non-metallic inclusions for cleaning (for example, a vacuum treatment of molten aluminum). The vacuum treatment is performed, for example, under conditions of 700° C. or higher and 800° C. or lower, 1 hour or longer and 10 hours or shorter, and a degree of vacuum of 0.1 Pa or more and 100 Pa or less.

As the treatment for cleaning the molten alloy, a treatment using a flux, or a treatment of blowing an inert gas or chlorine gas can also be used.

The obtained molten alloy is usually cast in a casting mold to obtain an ingot.

As the casting mold, an iron or graphite casting mold heated to 50° C. or higher and 200° C. or lower is used.

A material of the anode active material can be cast by a method of pouring a molten alloy at 680° C. or higher and 800° C. or lower into a casting mold. Alternatively, an ingot can also be obtained by semi-continuous casting which is generally used.

The obtained ingot of the aluminum alloy I can be directly cut and used as the material of the anode active material. The ingot may be processed into a plate material by rolling, extrusion, forging, or the like.

In a case where aluminum is used as the material of the anode, the above-described crystallite size of the anode surface can be controlled to less than 1000 Å, and in a case where the aluminum alloy 1 is used, the above-described crystallite size of the anode surface can be controlled to less than 900 Å.

The ingot of the aluminum or the aluminum alloy 1, which is the material of the anode, is first subjected to preliminary rolling to have a thickness of 1 to 5 mm. A rolling reduction and a temperature during rolling may be adjusted as appropriate.

By controlling rolling conditions of the aluminum material having a thickness of 1 to 5 mm after the preliminary rolling, the crystallite size of the anode surface can be controlled to 1000 Å or less.

Specifically, in the subsequent first rolling of the aluminum material having a thickness of 1 to 5 mm after the preliminary rolling, a preliminary heating temperature is preferably 310° C. or higher, and more preferably 320° C. or higher. An upper limit of the preliminary heating temperature is, for example, 500° C. or lower, preferably 400° C. or lower, and more preferably 350° C. or lower.

In a case where the preliminary heating temperature is lower than the above lower limit, rolling at the rolling reduction described below is difficult. In a case where the preliminary heating temperature exceeds the above upper limit, energy consumed by the heating is large, which leads to an increase in manufacturing cost.

In the first rolling, the rolling reduction is preferably 45% or more and 70% or less, more preferably 50% or more and 60% or less, and still more preferably 55% or more and 60% or less.

Here, the rolling reduction is a value calculated by the following expression.

Rolling reduction (%)=(thickness before rolling-thickness after rolling)/(thickness before rolling)×100

In the present embodiment, one or more rolling processes may be further performed after the first rolling. In this case, the next and subsequent rolling processes may be performed as cold rolling.

The thickness may become 200 μm or less by rolling after the first rolling, or may become 200 μm or less by the next and subsequent rolling processes.

By the rolling under the above-described conditions, a single layer of aluminum having a thickness of 200 μm or less is obtained as the anode of the present embodiment. Although a crystallite size of the aluminum is increased by the preliminary heating, the crystallite size of the anode surface can be controlled to 1000 Å or less by rolling at a predetermined rolling reduction. It is considered that this is because crystals that have grown significantly due to the preliminary heating are broken by rolling to become smaller

### <Manufacturing Method 2 of Anode for Lithium Secondary Battery>

A method of manufacturing the anode of the second embodiment will be described.

For the anode, a step of preparing each of a material of the anode active material layer and a material of the current collector layer, a step of roughening bonding surfaces, and a step of performing cladding rolling are included.

### [Step of Preparing Material of Anode Active Material Layer]

In a case where aluminum is used as the material of the anode active material layer, the aluminum is manufactured by performing the preliminary rolling of the method described above in (Manufacturing of Aluminum).

In a case where the aluminum alloy 1 is used as the material of the anode active material layer, the aluminum alloy is manufactured by performing the preliminary rolling of the method described above in (Manufacturing of Aluminum Alloy I).

### [Step of Preparing Material of Current Collector Layer]

In a case where the aluminum alloy 2 is used as a material of the current collector layer, the element M2 is added to molten aluminum and melted at 680° C. or higher and 800° C. or lower to obtain a molten alloy of Al and the element M2. The subsequent process is performed until the preliminary rolling of the same method as in [Step of Preparing Material of Anode Active Material Layer] described above to obtain the material of the current collector layer.

As the material of the current collector layer, a commercially available aluminum alloy 2 may be used. Examples of a commercially available product of the aluminum alloy 2 include A3003 (aluminum-manganese alloy) and A5052 (aluminum-magnesium alloy).

### [Roughening Step]

Each of bonding surfaces of the material of the anode active material layer and the material of the current collector layer thus obtained are roughened. Roughening enables stronger bonding between the anode active material layer and the current collector layer.

In the roughening step, surface roughnesses (Ra) of the bonding surfaces of the material of the anode active material layer and the material of the current collector layer are both set to preferably 0.7 μm or more, more preferably 0.8 μm or more, and still more preferably 1.0 μm or more by polishing the bonding surfaces.

In order to roughen the bonding surfaces of the material of the anode active material layer and the material of the current collector layer, known polishing means such as a brush or abrasive paper may be used.

### [Cladding Step]

After the roughening, the bonding surfaces of the material of the anode active material layer and the material of the current collector layer, which are roughened, are overlapped with each other to obtain a laminate. The laminate is subjected to preliminary beating at 300° C. or higher and hot-rolled to be cladded.

By controlling conditions of first rolling of the laminate, the crystallite size of the anode surface can be controlled to 1000 Å or less. Furthermore, the anode active material layer and the current collector layer are more strongly bonded to each other.

Specifically, in the first rolling, a preliminary heating temperature is preferably 310° C. or higher, and more preferably 320° C. or higher An upper limit of the preliminary heating temperature is, for example, 500° C. or lower, preferably 400° C. or lower, and more preferably 350° C. or lower

In the first rolling, the rolling reduction is preferably 45% or more and 70% or less, more preferably 50% or more and 60%, or less, and still more preferably 55% or more and 60%, or less.

Regardless of the combination of the material of the active material layer and the material of the current collector layer, the crystallite size can be controlled within the range of the present invention by setting the rolling reduction in the above range.

In the present embodiment, two or more rolling processes may be further performed after the first rolling. The second or subsequent rolling processes may be performed as cold rolling The thickness may become 200 μm or less by rolling after the first rolling, or may become 200 μm or less by the next and subsequent rolling processes.

By the rolling under the above-described conditions, a two-layer cladding material including the anode active material layer and the current collector layer and having a thickness of 200 μm or less is obtained as the anode of the present embodiment.

### <Manufacturing Method 3 of Anode for Lithium Secondary Battery>

A method of manufacturing the anode of the third embodiment will be described.

The anode can be manufactured by the same method as in <Manufacturing Method 2 of Anode for Lithium Secondary Battery> except that a laminate in which a pair of materials of the anode active material are directly laminated on both surfaces of the material of the current collector layer is obtained. In the method of manufacturing the anode of the third embodiment, a laminate obtained by combining the anode active material layer and the current collector layer may be obtained and then the anode active material layer may be laminated on a current collector layer side, or the pair of materials of the anode active material may be directly laminated on both surfaces of the current collector layer at once.

The materials of the anode active material layer may be the same as or different from each other. From the viewpoint of easily manufacturing, it is preferable that the materials of the anode active material have the same constituent metal element.

For example, in a case where aluminum X is used as the anode active material layer 11a, the anode active material layer 11b may use aluminum X, or may use aluminum Y, which has a different purity of Al from that of aluminum X.

The purities of the aluminum X and the aluminum Y may be adjusted as appropriate in the step of highly purifying the aluminum by the above-described segregation method or the three-layer electrolysis method.

In addition, for example, in a case where an aluminum alloy X is used as the anode active material layer 11a, the anode active material layer 11b uses an aluminum alloy Y having the same constituent metal element as that of the aluminum alloy X. The aluminum alloy X and the aluminum alloy Y may have the same or different content ratios of the element M1. In this case, the amount of the element M1 to be added to the molten aluminum may be adjusted as appropriate.

A three-layer cladding material including the anode active material layer and the current collector layer and having a thickness of 200 μm or less is obtained as the anode of the present embodiment by the same method as in <Manufacturing Method 2 of Anode for Lithium Secondary Battery> described above.

### <Lithium Secondary Battery>

Next, a secondary battery having the anode of the present embodiment will be described. As an example, a lithium secondary battery using a lithium cathode active material for the cathode will be described.

An example of the lithium secondary battery has a cathode, an anode, a separator interposed between the cathode and the anode, and an electrolytic solution disposed between the cathode and the anode.

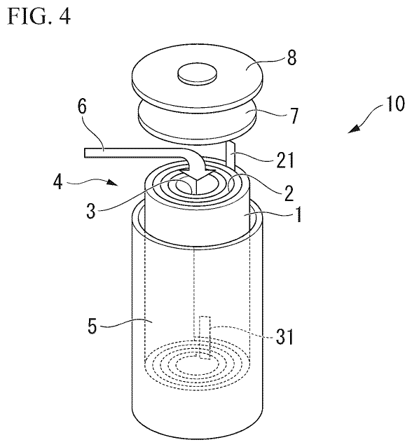

FIG. 4 is a schematic view showing an example of the lithium secondary battery. A cylindrical lithium secondary battery 10 is manufactured as follows.

First, as shown in FIG. 4, a pair of separators 1 having a strip shape, a strip-shaped cathode 2 having a cathode lead 21 at one end, and a strip-shaped anode 3 having an anode lead 31 at one end are stacked in order of the separator 1, the cathode 2, the separator 1, and the anode 3 and are wound to form an electrode group 4.

Next, the electrode group 4 and an insulator (not shown) are accommodated in a battery can 5, a can bottom is then sealed, the electrode group 4 is impregnated with an electrolytic solution 6, and an electrolyte is disposed between the cathode 2 and the anode 3. Furthermore, an upper portion of the battery can 5 is sealed with a top insulator 7 and a sealing body 8, whereby the lithium secondary battery 10 can be manufactured

Examples of a shape of the electrode group 4 include a columnar shape in which a cross-sectional shape when the electrode group 4 is cut in a direction perpendicular to a winding axis becomes a circle, an ellipse, a rectangle, or a rectangle with rounded comers.

In addition, as a shape of the lithium secondary battery having the electrode group 4, a shape defined by IEC60086, which is a standard for a battery defined by the International Electrotechnical Commission (IEC), or by JIS C 8500 can be adopted. Examples thereof include shapes such as a cylindrical shape or a square shape.

Furthermore, the lithium secondary battery is not limited to the wound type configuration, and may have a stacked type configuration in which a stacked structure of a cathode, a separator, an anode, and a separator is repeatedly stacked. A so-called com type battery, a button type battery, and a paper type (or sheet type) battery are exemplary examples of the stacked type lithium secondary battery.

Hereinafter, each configuration will be described in order.

### (Cathode)

The cathode can be manufactured by first adjusting a cathode mixture containing a cathode active material, a conductive material, and a binder, and supporting the cathode mixture by a cathode current collector

### (Cathode Active Material)

As the cathode active material, a material containing a lithium-containing compound or a compound containing another metal can be used. Examples of the lithium-containing compound include a lithium cobalt complex oxide having a layered structure, a lithium nickel complex oxide having a layered structure, a lithium manganese complex oxide having a spinel structure, and a lithium iron phosphate having an olivine structure. Examples of the compound containing another metal include oxides such as titanium oxide, vanadium oxide, and manganese dioxide, and sulfides such as titanium sulfide and molybdenum sulfide.

### (Conductive Material)

As the conductive material included in the cathode, a carbon material can be used. Examples of the carbon material include graphite powder, carbon black (for example, acetylene black), and a fibrous carbon material.

A proportion of the conductive material in the cathode mixture is preferably 5 to 20 parts by mass with respect to 100 parts by mass of the cathode active material.

### (Binder)

As the binder in the cathode, a thermoplastic resin can be used. As the thermoplastic resin, polyimide resins; fluororesins such as polyvinylidene fluoride (hereinafter, sometimes referred to as PVdF) and polytetrafluoroethylene; polyolefin resins such as polyethylene and polypropylene, and the resins described in WO 2019/098384A1 or US2020/0274158A1 can be exemplary examples.

### (Cathode Current Collector)

As the cathode current collector included in the cathode, a strip-shaped member formed of a metal material such as Al, Ni, or stainless steel as a forming material can be used.

As a method for supporting the cathode mixture by the cathode current collector, a method in which a paste of the cathode mixture is prepared using an organic solvent, the obtained paste of the cathode mixture is applied to at least one surface side of the cathode current collector and dried, and the paste is fixed by performing an electrode pressing step is an exemplary example.

As the organic solvent that can be used in a case where the paste of the cathode mixture is prepared, N-methyl-2-pyrrolidone (hereinafter, referred to as NMP in some cases) is an exemplary example.

Examples of a method of applying the paste of the cathode mixture to the cathode current collector include a slit die coating method, a screen coating method, a curtain coating method, a knife coating method, a gravure coating method, and an electrostatic spraying method.

The cathode can be manufactured by the method mentioned above.

### (Anode)

As the anode included in the lithium secondary battery of the present embodiment, the anode of the present embodiment described above is used.

### (Anode Current Collector)

The anode of the present embodiment is a current collector-integrated anode. The current collector-integrated anode may be used alone, or may be used in combination with a current collector.

### (Separator)

As the separator included in the lithium secondary battery, for example, a material that is made of a material such as a polyolefin resin such as polyethylene or polypropylene, a fluororesin, or a nitrogen-containing aromatic polymer and has a form such as a porous film, a non-woven fabric, or a woven fabric can be used. In addition, two or more of these materials may be used to form the separator, or these materials may be laminated to form the separator.

In the present embodiment, an air resistance of the separator according to the Gurley method defined by JIS P 8117 is preferably 50 sec/100 cc or more and 300 sec/100 cc or less, and more preferably 50 sec/100 cc or more and 200 sec/100 cc or less in order for the electrolyte to have good permeation during battery use (during charging and discharging).

In addition, a porosity of the separator is preferably 30 vol % or more and 80 vol % or less and more preferably 40 vol % or more and 70 vol % or less with respect to a total volume of the separator The separator may be a laminate of separators having different porosities.

### (Electrolytic Solution)

The electrolytic solution included in the lithium secondary battery contains an electrolyte and an organic solvent.

Examples of the electrolyte contained in the electrolytic solution include lithium salts such as LiClO₄, LiPF₆, LiAsF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (here, BOB refers to bis(oxalato)borate), LiFSI (here, FSI refers to bis(fluorosulfonylimide), lower aliphatic carboxylic acid lithium salts, and LiAlCl₄, and a mixture of two or more of these may be used. Among these, as the electrolyte, it is preferable to use at least one selected from the group consisting of LiPF₆, LiAsF₆, LiSbF₆, LiBF₄, LiCF₃SO₃, LiN(SO₂CF₃)₂, and LiC(SO₂CF₃)₃, which contain fluorine.

In addition, as the organic solvent that is contained in the electrolytic solution, for example, carbonates such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, propyl propionate, and γ-butyrolactone; nitriles such as acetonitrile and butyronitrile; amides such as N,N-dimethylformamide and N,N-dimethylacetamide; carbamates such as 3-methyl-2-oxazolidone; and sulfur-containing compounds such as sulfolane, dimethyl sulfoxide, and 1,3-propanesultone, or those obtained by further introducing a fluoro group into these organic solvents (those obtained by substituting one or more hydrogen atoms in the organic solvents with a fluorine atom) can be used.

As the organic solvent, it is preferable to use a mixture of two or more thereof. Among these, a mixed solvent containing a carbonate is preferable, and a mixed solvent of a cyclic carbonate and a non-cyclic carbonate and a mixed solvent of a cyclic carbonate and an ether are more preferable. As the mixed solvent of a cyclic carbonate and a non-cyclic carbonate, a mixed solvent containing ethylene carbonate, dimethyl carbonate, and ethyl methyl carbonate is preferable. An electrolytic solution using such a mixed solvent has a wide operating temperature range, does not easily deteriorate even when charging and discharging are performed at a high current rate, and does not easily deteriorate even during a long-term use.

Furthermore, as the electrolytic solution, it is preferable to use an electrolytic solution containing a lithium salt containing fluorine such as LiPF₆ and an organic solvent having a fluorine substituent in order to enhance the safety of the obtained lithium secondary battery. A mixed solvent containing an ether having a fluorine substituent such as pentafluoropropyl methyl ether or 2,2,3,3-tetrafluoropropyl difluoromethyl ether and dimethyl carbonate is even more preferable because a capacity retention ratio is high even when charging and discharging are performed at a high current rate.

The electrolytic solution may contain additives such as tris(trimethylsilyl) phosphate and tris(trimethylsilyl) borate.

A solid electrolyte may be used instead of the electrolytic solution. As the solid electrolyte, for example, an organic polymer electrolyte such as a polyethylene oxide-based polymer compound, or a polymer compound containing at least one or more of a polyorganosiloxane chain or a polyoxyalkylene chain can be used. A so-called gel type in which a non-aqueous electrolytic solution is held in a polymer compound can also be used. In addition, inorganic solid electrolytes containing sulfides such as Li₂S-SiS₂, Li₂S-GeS₂, Li₂S-P₂S₅, Li₂S-B₂S₃, Li₂S-SiS₂-L₃PO₄, Li₂S-SiS₂-Li₂SO₄, and Li₂S-GeS₂-P₂S₅ can be adopted, and a mixture of two or more thereof may be used. By using these solid electrolytes, the safety of the lithium secondary battery can be further enhanced.

In addition, in a case of using the solid electrolyte in the lithium secondary battery of the present embodiment, there may be cases where the solid electrolyte serves as the separator, and in such a case, the separator may not be required.

The present invention includes the following [11] to [20].

[11] A anode for a lithium secondary battery, including: aluminum, in which a thickness of the anode for a lithium secondary battery is 1 μm or more and 200 μm or less, in which, in X-ray diffraction measurement of a anode surface of the anode for a lithium secondary battery using CuKα as a radiation source, a crystallite size calculated from a half-width of a diffraction peak of an aluminum (311) plane is 300 Å or more and less than 1000 Å.

[12] The anode for a lithium secondary battery according to [11], in which a material of the anode for a lithium secondary battery is aluminum, and a content ratio of an inevitable impurity contained in the aluminum is less than 0.1 mass %.

[13] The anode for a lithium secondary battery according to [11] or [12], in which a material of the anode for a lithium secondary battery is an alloy of aluminum and an element M1, the element M1 is one or more elements selected from the group consisting of Si, Ge, Sn, Ag, Sb, Bi, In, Mn, and Mg, and a content ratio of the element M1 to a total amount of the anode for a lithium secondary battery is 0.5 mass % or more and 7.8 mass % or less.

[14] A anode for a lithium secondary battery including: a cladding material including a anode active material layer and a current collector layer, in which a thickness of the anode for a lithium secondary battery is 1 μm or more and 200 μm or less, in which, in X-ray diffraction measurement of a anode surface of the anode for a lithium secondary battery using CuKα as a radiation source, a crystallite size calculated from a half-width of a diffraction peak of an aluminum (311) plane is 300 Å or more and less than 1000 Å.

[15] The anode for a lithium secondary battery according to [14], in which a material of the current collector layer is an aluminum alloy having a lower content ratio of Al than the anode active material layer.

[16] The anode for a lithium secondary battery according to [4] or [5], in which a material of the current collector layer contains an element M2 which is one or more elements selected from the group consisting of Si, Fe, Ni, Cu, Mn, and Mg, and a content ratio of the element M2 to a total amount of the current collector layer is 1 mass % or more and 5 mass % or less.

[17] The anode for a lithium secondary battery according to any one of [14] to [16], in which a material of the anode active material layer is aluminum, and a content ratio of an inevitable impurity contained in the aluminum is less than 0.1 mass %.

[18] The anode for a lithium secondary battery according to any one of [14] to [17], in which a material of the anode active material layer is an alloy of aluminum and an element M1, the element M1 is one or more elements selected from the group consisting of Si, Ge, Sn, Ag, Sb, Bi, In, Mn, and Mg, and a content ratio of the element M1 to a total amount of the anode active material layer is 0.5 mass % or more and 7.8 mass % or less.

[19] The anode for a lithium secondary battery according to any one of [11] to [18], in which a crystallite size is 500 Å or more and less than 800 Å.

[20] A lithium secondary battery including: the anode for a lithium secondary battery according to any one of [11] to [19].

### EXAMPLES

Next, the present invention will be described in more detail with reference to examples.

### Example 1

### [Production of Anode]

### Preparation of Material of Anode Active Material Layer

As the material of the anode active material layer, an aluminum-silicon alloy 1, which was an alloy of aluminum having a purity of Al of 99.99 mass % or more and silicon, was manufactured.

First, aluminum having a purity of Al of 99.99 mass % or more and silicon manufactured by Tokuyama Corporation and having a purity of Si of 99.999 mass % or more were heated and held at 760° C. to be melted, thereby obtaining a molten aluminum-silicon alloy.

Next, the molten aluminum-silicon alloy was held at 700° C. for 2 hours under a condition of a degree of vacuum of 50 Pa to be cleaned and stirred, and then cast in a cast iron casting mold (22 mm×150 mm×200 mm) dried at 150° C., thereby obtaining an aluminum-silicon ingot. At this time, a ratio of Si to a total mass of the aluminum-silicon ingot was 1 mass %. Thereafter, the aluminum-silicon ingot was subjected to a homogenization treatment at 550° C., to surface cutting, and then to cold rolling (preliminary rolling) until an aluminum-silicon rolled material had a thickness of 300 μm, thereby obtaining an aluminum-silicon rolled material 1.

### Preparation of Material of Current Collector Layer

As the material of the current collector layer, a rolled material of A5052 alloy, which is a typical aluminum-magnesium alloy, was used.

### Surface Treatment

Bonding surfaces of the aluminum-silicon rolled material 1 as the material of the anode active material layer and the aluminum-magnesium alloy as the material of the current collector layer were each degreased, and polished in one direction using a brush. Accordingly, a surface roughness Ra of the bonding surface of the aluminum-silicon rolled material 1 was 1.0 μm, and a surface roughness Ra of the bonding surface of the aluminum-magnesium alloy was 1.0 μm.

### Rolling of Laminate

The bonding surfaces of the aluminum-silicon rolled material 1 and the aluminum-magnesium alloy were bonded to each other to obtain a laminate 1. The obtained laminate 1 was subjected to preliminary heating at 350° C. and was hot-rolled under a condition in which a rolling reduction in first rolling was 50%. Additional cold rolling was then performed to obtain a rolled material in which the thickness of the anode active material layer was 25 μm. The rolled material was cut into a disk shape having a diameter of Φ15 mm, thereby manufacturing a anode including the anode active material layer and the current collector layer.

### [Manufacturing of Lithium Secondary Battery]

A lithium secondary battery was manufactured by the method described above in (Manufacturing of Lithium Secondary Battery).

### [Measurement of Crystallite Size]

A crystallite size was measured by the method described above in [Measurement of Crystallite Size].

As a result, the crystallite size of the anode of Example 1 was 658 Å.

Furthermore, a cycle retention ratio was measured by the method described above in [Method of Measuring Cycle Retention Ratio], and was 91%.

### Example 2

A3003 (aluminum-manganese alloy) was used as a material of the current collector layer, and a laminate 2 was obtained in the same manner as in Example 1. The laminate 2 was subjected to preliminary heating at 350° C. and was hot-rolled under a condition in which a rolling reduction in first rolling was 50%. Thereafter, second hot rolling was additionally performed in the same manner as in the first rolling to obtain a rolled material in which the thickness of the anode active material layer was 25 μm. A anode was manufactured in the same manner as in Example 1.

In Example 2, a crystallite size was 767 Å.

Furthermore, a cycle retention ratio was 98%.

### Example 3

A laminate 1 was obtained by the same method as in Example 1. The laminate 1 was subjected to preliminary heating at 350° C. and was hot-rolled under a condition in which a rolling reduction in first rolling was 50%. Thereafter, second hot rolling was additionally performed in the same manner as in the first rolling to obtain a rolled material in which the thickness of the anode active material layer was 25 μm. A anode was manufactured in the same manner as in Example 1.

In Example 3, a crystallite size was 630 Å.

Furthermore, a cycle retention ratio was 91%.

### Example 4

A laminate 1 was obtained by the same method as in Example 1. The laminate 1 was subjected to preliminary heating at 300° C. and was hot-rolled under a condition in which a rolling reduction in first rolling was 50%. Thereafter, second hot rolling was additionally performed in the same manner as in the first rolling to obtain a rolled material in which the thickness of the anode active material layer was 25 μm. A anode was manufactured in the same manner as in Example 1.

In Example 4, a crystallite size was 569 Å.

Furthermore, a cycle retention ratio was 97%.

### Example 5

An aluminum-silicon rolled material 2 was obtained in the same manner as in Example 1, except that the aluminum-silicon rolled material 2 was subjected to cold rolling (preliminary rolling) to a thickness of 4 mm. The obtained aluminum-silicon rolled material 2 was then heated to 350° C., and subjected to first hot rolling at a rolling reduction of 50%. Furthermore, cold rolling was performed thereon until the thickness reached 50 μm, thereby manufacturing a current collector-integrated anode including the anode active material layer and the current collector layer.

In Example 5, a crystallite size was 591 Å.

Furthermore, a cycle retention ratio was 99%.

### Comparative Example 1

A material of a anode active material layer and a material of a current collector layer were prepared in the same manner as in Example 1, and a laminate in which the material of the anode active material layer and the material of the current collector layer were laminated was prepared. When the laminate was subjected to cold rolling without the preliminary heating, the laminate could not be cladded.

### Comparative Example 2

Bonding surfaces of an aluminum-silicon rolled material 1 and an aluminum-magnesium alloy were bonded to each other to obtain a laminate 1. The obtained laminate 1 was subjected to preliminary heating at 350° C. and was hot-rolled under a condition in which a rolling reduction in first rolling was 50%, and additional cold rolling was then performed to obtain a rolled material A in which a thickness of a anode active material layer was 25 μm. The rolled material A was subjected to final annealing at 350° C. for 3 hours to manufacture a anode.

In Comparative Example 2, a crystallite size was 1083 Å.

Furthermore, a cycle retention ratio was 30%.

### Comparative Example 3

An aluminum foil having a thickness of 50 μm and a purity of 99.999% was subjected to final annealing at 350° C. for 3 hours, thereby manufacturing a current collector-integrated anode including a anode active material layer and a current collector layer.

In Comparative Example 3, a crystallite size was 1200 Å.

Furthermore, a cycle retention ratio was 10%.

In Examples 1 to 5, the cycle retention ratios were as high as 90% or more. This is considered to be because, due to a small crystallite size of the anode surface, a lithium alloying reaction had proceeded uniformly in a depth direction across the entire anode surface in a case where charging and discharging were repeated.

It is considered that the reason why the cycle retention ratios of Comparative Examples 2 and 3 were as low as 30% or less was that, due to a large crystallite size of the anode surface, a lithium alloying reaction had proceeded locally in a case where charging and discharging were repeated, and a part of the anode was broken.

### REFERENCE SIGNS LIST

1: Separator
3: Anode
4: Electrode group
5: Battery can
6: Electrolytic solution
7: Top insulator
8: Sealing body
10: Lithium secondary battery
21: Cathode lead
100, 101, 102: Anode for a lithium secondary battery
11, 11a, 11b: Anode active material layer
12: Current collector layer

1. An anode for a lithium secondary battery, comprising:
aluminum,
wherein a thickness of the anode for a lithium secondary battery is 200 μm or less, and
in X-ray diffraction measurement of an anode surface of the anode for a lithium secondary battery using CuKα as a radiation source, a crystallite size calculated from a half-width of a diffraction peak of an aluminum (311) plane is less than 1000 Å.

2. The anode for a lithium secondary battery according to claim 1,
wherein a material of the anode for a lithium secondary battery is aluminum, and
a content ratio of an inevitable impurity contained in the aluminum is less than 0.1 mass %.

3. The anode for a lithium secondary battery according to claim 1,
wherein a material of the anode for a lithium secondary battery is an alloy of aluminum and an element M1,
the element M1 is one or more elements selected from the group consisting of Si, Ge, Sn, Ag, Sb, Bi, In, Mn, and Mg, and
a content ratio of the element M1 to a total amount of the anode for a lithium secondary battery is 0.1 mass % or more and 8 mass % or less.

4. An anode for a lithium secondary battery, comprising:
a cladding material including an anode active material layer and a current collector layer,
wherein a thickness of the anode for a lithium secondary battery is 200 μm or less, the anode active material layer contains aluminum, and
in X-ray diffraction measurement of an anode surface of the anode for a lithium secondary battery using CuKα as a radiation source, a crystallite size calculated from a half-width of a diffraction peak of an aluminum (311) plane is less than 1000 Å.

5. The anode for a lithium secondary battery according to claim 4,
wherein a material of the current collector layer is an aluminum alloy having a lower content ratio of Al than the anode active material layer.

6. The anode for a lithium secondary battery according to claim 4,
wherein a material of the current collector layer contains an element M2 which is one or more elements selected from the group consisting of Si, Fe, Ni, Cu, Mn, and Mg, and
a content ratio of the element M2 to a total amount of the current collector layer is 0.1 mass % or more.

7. The anode for a lithium secondary battery according to claim 4,
wherein a material of the anode active material layer is aluminum, and
a content ratio of an inevitable impurity contained in the aluminum is less than 0.1 mass %.

8. The anode for a lithium secondary battery according to claim 4,
wherein a material of the anode active material layer is an alloy of aluminum and an element M1,
the element M1 is one or more elements selected from the group consisting of Si, Ge, Sn, Ag, Sb, Bi, In, Mn, and Mg, and
a content ratio of the element M1 to a total amount of the anode active material layer is 0.1 mass % or more and 8 mass % or less.

9. The anode for a lithium secondary battery according to claim 1,
wherein the crystallite size is less than 900 Å.

10. A lithium secondary battery comprising:
the anode for a lithium secondary battery according to claim 1.

11. The anode for a lithium secondary battery according to claim 2,
wherein a material of the anode for a lithium secondary battery is an alloy of aluminum and an element M1,
the element M1 is one or more elements selected from the group consisting of Si, Ge, Sn, Ag, Sb, Bi, In, Mn, and Mg, and
a content ratio of the element M1 to a total amount of the anode for a lithium secondary battery is 0.1 mass % or more and 8 mass % or less.

12. The anode for a lithium secondary battery according to claim 5,
wherein a material of the current collector layer contains an element M2 which is one or more elements selected from the group consisting of Si, Fe, Ni, Cu, Mn, and Mg, and
a content ratio of the element M2 to a total amount of the current collector layer is 0.1 mass % or more.

13. The anode for a lithium secondary battery according to claim 5,
wherein a material of the anode active material layer is aluminum, and
a content ratio of an inevitable impurity contained in the aluminum is less than 0.1 mass %.

14. The anode for a lithium secondary battery according to claim 5,
wherein a material of the anode active material layer is an alloy of aluminum and an element M1,
the element M1 is one or more elements selected from the group consisting of Si, Ge, Sn, Ag, Sb, Bi, In, Mn, and Mg, and
a content ratio of the element M1 to a total amount of the anode active material layer is 0.1 mass % or more and 8 mass % or less.

15. The anode for a lithium secondary battery according to claim 2,
wherein the crystallite size is less than 900 Å.

16. A lithium secondary battery comprising:
the anode for a lithium secondary battery according to claim 2.
